(19) United States
(12) Patent Application Publication
(10) Pub. No.: US 2009/0015051 A1
(43) Pub. Date: Jan. 15, 2009

(54) VERTICAL SPRINGING DEVICE OF A TELESCOPIC ELEMENT WITH RESPECT TO A FIXED ELEMENT

(75) Inventor: Eugenio Fraenkel Haeberle, Udine (IT)

Correspondence Address: Novak Druce + Quigg, LLP, 1300 Eye Street, NW, Suite 1000, Suite 1000, West Tower, Washington, DC, 20005, US

(73) Assignee: F.I.S.A.-Fabbrica Italiana Sedili Autoferroviari- SRL, Osoppo (IT)

(21) Appl. No.: 12/281,319

(22) PCT Filed: Mar. 9, 2007
(86) PCT No.: PCT/IB2007/000549

§ 371 Date: Aug. 30, 2008

(30) Foreign Application Priority Data
Mar. 10, 2006 (IT) UD2006A000056

(51) Int. Cl. A47C 3/30; A47C 3/20; A47C 3/40; F16M 13/00; F16F 9/32; F16F 9/00; F16F 3/07

(52) U.S. Cl. 297/344.19; 248/565; 267/117

(57) ABSTRACT

A vertical springing device to allow the vertical springing and absorption of vibrations of a first telescopic element, in particular connected to the seat-part of a seat, with respect to a second fixed element, in particular connected to the base of the seat, comprises adjustment means of the elastic type, disposed inside the first telescopic element and able to adjust in height the level of the first telescopic element with respect to the second fixed element, and a springing mechanism, for the vertical springing of the first telescopic element with respect to the second fixed element.

### FIELD OF THE INVENTION

The present invention concerns a vertical springing device of a telescopic element with respect to a fixed element, in particular for the vertical springing, and also the adjustment in height, of the upper part, or seat-part, of a seat, such as for example a seat that can be used in the driving seats of public transport means, ships, motor vehicles, in the office, or other.

### BACKGROUND OF THE INVENTION

It is known to achieve springing devices for the vertical springing, and also the adjustment in height, of a telescopic element with respect to a fixed element, in particular for the vertical springing of the upper part, or seat-part, of a seat, such as for example a seat that can be used in the driving seats of public transport means, motor vehicles, in the office, or other. Such seats must respect strict regulations concerning safety and ergonomics. For example, the seats have to have the seat-part adjustable in height in a plurality of stable positions. Moreover, in each stable position of the seat-part, the seat-part must be able to spring in a travel of several centimeters and must be rotatable through 360 degrees with respect to the central axis of the seat, irrespective of the adjustment in height and of the springing.

Said seats must also be robust, so as to resist, without bending or getting damaged, considerable transverse or normal thrusts or impacts, particularly in the region which functions as a headrest, in whatever vertical position the seat-part finds itself.

In particular, it is known to equip said seats with units for springing and for absorbing vibrations, also provided with systems for pre-loading the springing, and with the possibility of adjusting the height of the seat-part with respect to the base of the seat by means of pantograph-type movement devices.

One disadvantage of such springing and absorbing units is that they are separated from the seat and must be positioned under the seat, thus increasing the overall bulk of the seat area. Known devices are also costly and complex and are not integrated and compact with the seat, in particular with its support. This applies both for the deadening and absorption of the vibrations, and also for the adjustment in height of the seat-part with respect to the base support.

Another disadvantage of such springing and absorbing units is that the system to pre-load the springing, with which they are provided, is not ergonomic for the user who, in any case, has to get off the seat in order to act upon a command lever to change the setting, as he desires, for deadening the vibrations.

One purpose of the present invention is to achieve a vertical springing and vibration absorption device which is compact and integrated with the guide and sliding system, which is easy to make and economical.

Another purpose of the present invention is to achieve a springing device that is compact and that also allows to adjust the height of the telescopic element with respect to the fixed element.

Another purpose of the present invention is to achieve a springing device having a unit to adjust the pre-loading of the springing that is compact and ergonomical.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a springing device is able to allow the vertical springing and absorption of the vibrations of a first telescopic element, in particular connected to the seat-part of a seat, with respect to a second fixed element, in particular connected to the base of the seat. According to a characteristic feature of the present invention, the springing device comprises elastic-type adjustment means, disposed inside the first telescopic element and able to adjust in height the position of the first telescopic element with respect to the second fixed element. The springing device according to the present invention also comprises a springing mechanism, able to allow the vertical springing of the first telescopic element with respect to the second fixed element, consisting of springing means and deadening means.

According to one embodiment of the invention, the deadening means is disposed central and the elastic-type adjustment means is disposed at the sides thereof, on diametrically opposite sides. The springing means and the deadening means are thus coaxial with each other and associated by an annular element to support the axial movement, in turn connected to the springing means.

According to another embodiment of the invention, the elastic-type adjustment means is disposed centrally and the deadening means is disposed at the sides thereof, on diametrically opposite sides. The springing means and the elastic-type adjustment means are thus coaxial with each other.

According to another characteristic of the present invention, the springing unit comprises a unit to adjust the pre-load of said springing means, provided with a command rod with an adjustment knob disposed in proximity with the vertical. The command rod is thus slightly angled with respect to the vertical axis and is positioned in proximity with the seat-part, in order to be easily accessible for the user.

Thus, advantageously, we obtain a springing unit coaxial with the base support, which is extremely compact and also integrated with the unit to adjust the pre-load, exploiting the spaces available in a functional manner.

According to another characteristic of the present invention, the springing device also cooperates with a command device, which is able to selectively command the drive of said means to adjust the height of the first telescopic element, in particular connected to the seat-part of a seat, which is rotatable by 360 degrees with respect to the axis of said first telescopic element, with respect to the second fixed element, in particular connected to the base of the seat. According to a characteristic feature of the present invention, the command device comprises a command lever that is pivoted on the lower part of said seat-part and is able to drive a central platelet with which mechanical connecting means cooperate, which controls said adjustment means so as to command, from any angular position of said seat-part, the drive of said adjustment means.

According to another characteristic of the present invention, the springing device cooperates, in particular in a seat, with a guide device, associated with the seat, able to allow the axial sliding of the first telescopic element, in particular connected to the upper part or seat-part of a seat, inside the second vertical fixed element. The fixed element comprises a profile which for example is made of extruded metal material, which is shaped so as to define internally vertical guide means with which interposition means cooperates, positioned between the first telescopic element and the second fixed element, in order to promote the reciprocal axial sliding of the first telescopic element with respect to the second fixed element.

According to one embodiment of the invention, the interposition means is a sliding means, protruding radially from said first telescopic element.

Advantageously, the telescopic element also comprises a profile provided with flat faces that cooperate with other sliding means, protruding radially from said fixed element.

According to another embodiment of the invention, the interposition means is roller means able to slide along suitable metal blades disposed along the first and second telescopic element.

Advantageously, the guide device according to the present invention is thus particularly compact, robust and resistant to flexion, light, economical and easy to produce, advantageously by means of extrusion. Moreover, it can be made to size as desired, constituting a modular system in height, and thus adaptable to various design requirements. Advantageously, the guide device according to the present invention does not need maintenance for lubrication of its components and is resistant to corrosion by means of a process to anodize the metal of which it is made.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a lateral section view of a seat provided with a springing device according to the invention, in a retracted position;

FIG. 2 is a lateral section view of the seat in FIG. 1, in an extended position;

FIG. 3 is a plane cross section view of the seat in FIG. 1;

FIG. 4 is an enlarged detail of FIG. 1;

FIG. 5 is a front section view of the seat in FIG. 1, in a retracted position;

FIG. 6 is a front section view of the seat in FIG. 1, in an extended position;

FIG. 7 is a first enlarged detail of FIG. 6;

FIG. 8 is a second enlarged detail of FIG. 5;

FIG. 9 is a third enlarged detail of FIG. 6;

FIG. 10 is a lateral section view of a seat provided with a variant of a springing device according to the invention, in a retracted position;

FIG. 11 is a plane view in cross section of the seat in FIG. 10;

FIG. 12 is an enlarged detail of FIG. 11;

FIG. 13 is a view of a part of the springing device in FIG. 10;

FIG. 14 is a view of another part of the springing device in FIG. 10;

FIG. 15 is an enlarged detail of FIG. 10; and

FIG. 16 is a front section view of the seat in FIG. 10, in a retracted position.

### DETAILED DESCRIPTION OF A PREFERENTIAL FORM OF EMBODIMENT

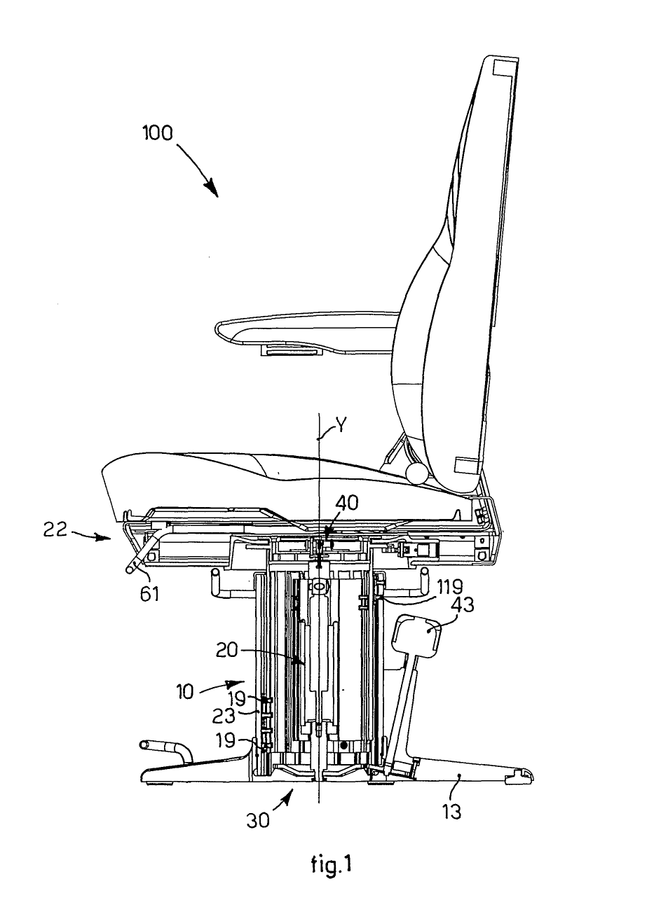

With reference to FIG. 1, a vertical springing device 20 according to the present invention is shown associated with a guide device 10 inserted in a seat 100, of which it is the base support. The seat 100 comprises a seat-part 22, of the type rotatable through 360 degrees with respect to a vertical axis Y and is adjustable in height.

The guide device 10 comprises a telescopic element, in this specific case consisting of a rod 11 which is connected rotatably to the seat-part 22.

The guide device 10 also comprises a fixed cylinder 12, inside which the rod 11 is inserted coaxially. The reciprocal axial position of the cylinder 12 and the rod 11 is selectable as desired by the user (FIGS. 1, 2, 5 and 6).

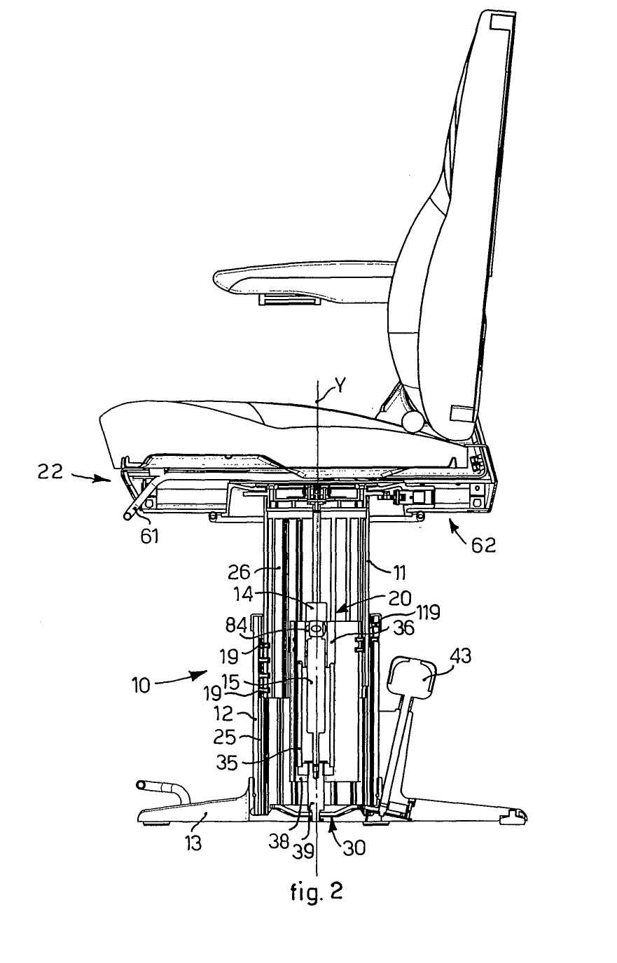

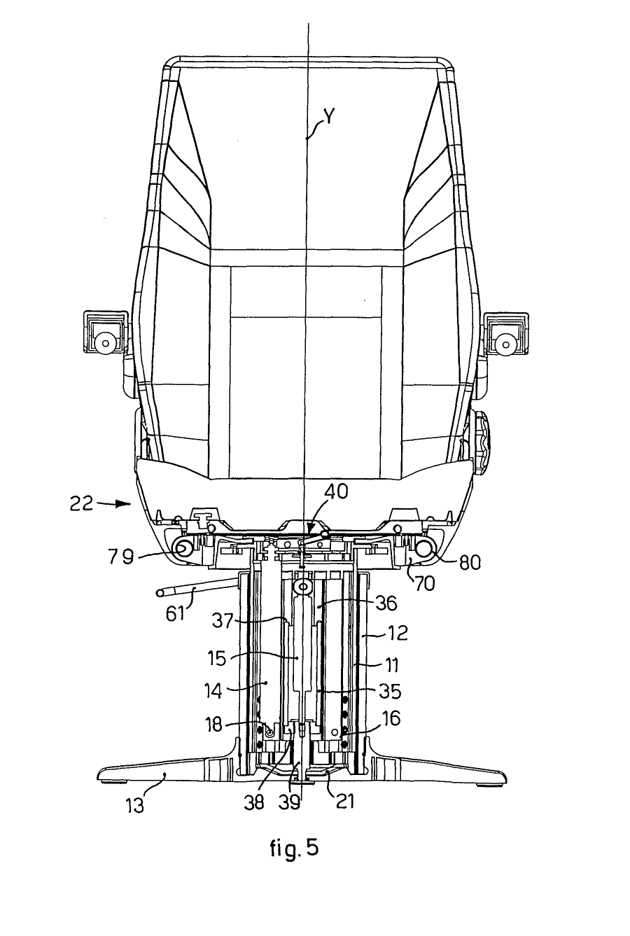

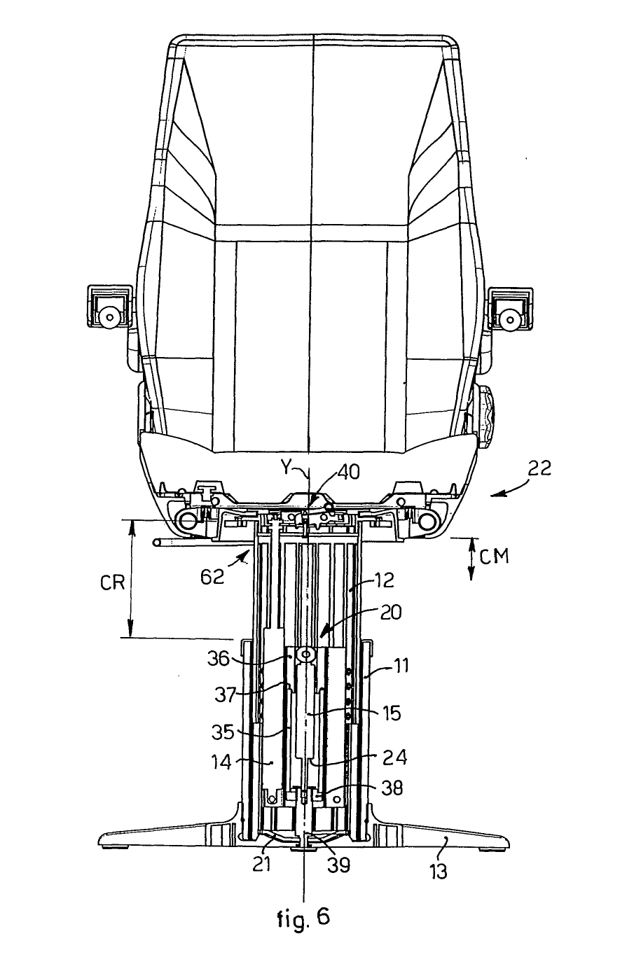

This axial sliding occurs along the axis Y, between a retracted position shown in FIGS. 1 and 5 and an extended position shown in FIGS. 2 and 6.

Five radial spokes 13 are fixed to the lower part of the cylinder 12, for horizontal support, associated with the base support 23, and able to be fixed to or rested on the floor, in order to give stability to the seat 100.

Advantageously, both the rod 11 and the cylinder 12 each comprise a metal profile, for example aluminum, obtained by extrusion, drawing or removal of material.

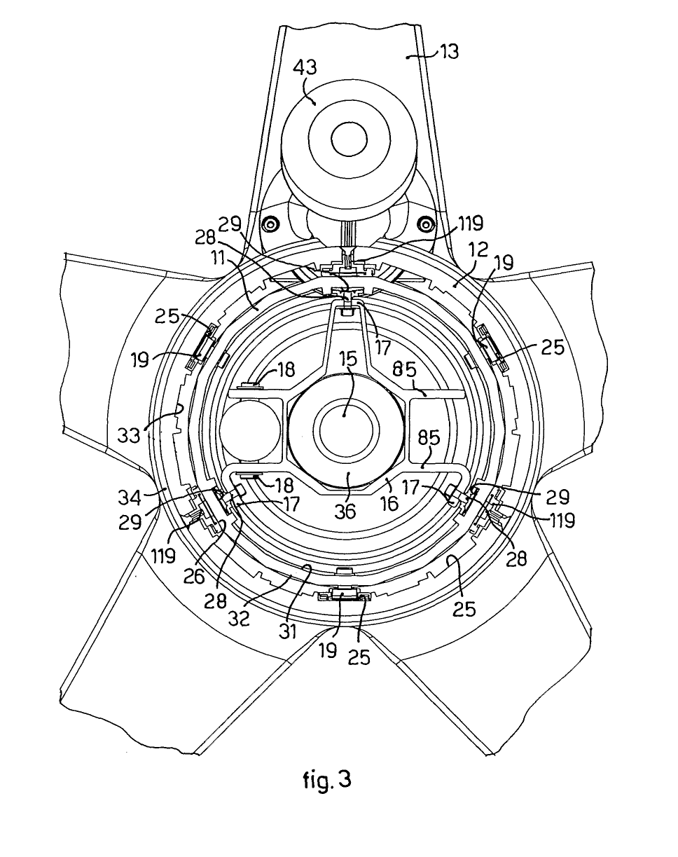

The cylinder 12 is shaped so as to have internally a plurality of vertical grooves or guides 25, in this specific case nine, each disposed off-set angularly by 40 degrees with respect to the adjacent one (FIG. 3).

Three of the vertical grooves 25, off-set angularly with respect to each other by 120 degrees, function as guides. for sliding means 19, associated with the rod 11.

In particular, the sliding means consists of groups of pads 19 made of material with a low friction coefficient and, advantageously self-lubricating, fixed to the external surface 32 of the rod 11, also off-set angularly by 120 degrees.

In this way the rod 11 can slide axially with respect to the cylinder 12, guided mainly by the pads 19.

Moreover, the cylinder 12 is provided with three groups of pads 119 (FIG. 3), which extend towards the inside, until they touch the external lateral surface 32 of the rod 11, and are off-set by 120 degrees with respect to each other and by 60 degrees with respect to the pads 19.

The pads 19 of the rod 11 function both as angular centering means and also as axial sliding means for the rod 11 with respect to the cylinder 12, because they slide inside the vertical guides 25 (FIG. 3).

Advantageously, the pads 119 contribute to keeping the rod 11 and the cylinder 12 coaxial with each other. In particular, the pads 119 cooperate with three flat faces 26, disposed angularly off-set with respect to each other by 120 degrees, which are made on the external lateral surface 32 of the rod 11.

Both the guides 25 and the flat faces 26 are made directly during the extrusion of the cylinder 12 and, respectively, the rod 11. In this way, a considerable advantage is obtained in terms of time and costs, and it is possible to size and shape both the flat faces 26 and the guides 25 according to design requirements. Therefore, the guide device 10 is particularly light and compact.

According to another characteristic feature of the present invention, a vertical springing device 20 is used to determine and adjust the height of the relative position of the rod 11 with respect to the cylinder 12, and hence the position in height of the seat-part 22, with respect to the spokes 13, used by the user, and also the springing of the rod 11 with respect to the cylinder 12, when their position is determined. The vertical springing device 20 comprises two gas springs 14 (FIGS. 1, 2 and 3), of a known type, which can assume, as desired by the user, an infinite number of rigid configurations, that is, stable vertical positions, both in extension and also in contraction, along the axis Y. As an alternative to the gas springs, mechanical springs can be used which allow the adjustment in height, or other types.

The gas springs 14 are inserted axially into the rod 11 and their vertical extension can be selected by the user. According to one form of embodiment of the present invention, the gas springs 14 are disposed diametrically opposite with respect to the axis Y (FIGS. 3, 5 and'6).

The gas springs 14 are selectively activated, in extension upwards or in contraction downwards, along an adjustment travel CR (FIGS. 5 and 6) and correspondingly influence the axial position of the rod 11 too, extracting it from or inserting it along the cylinder 12.

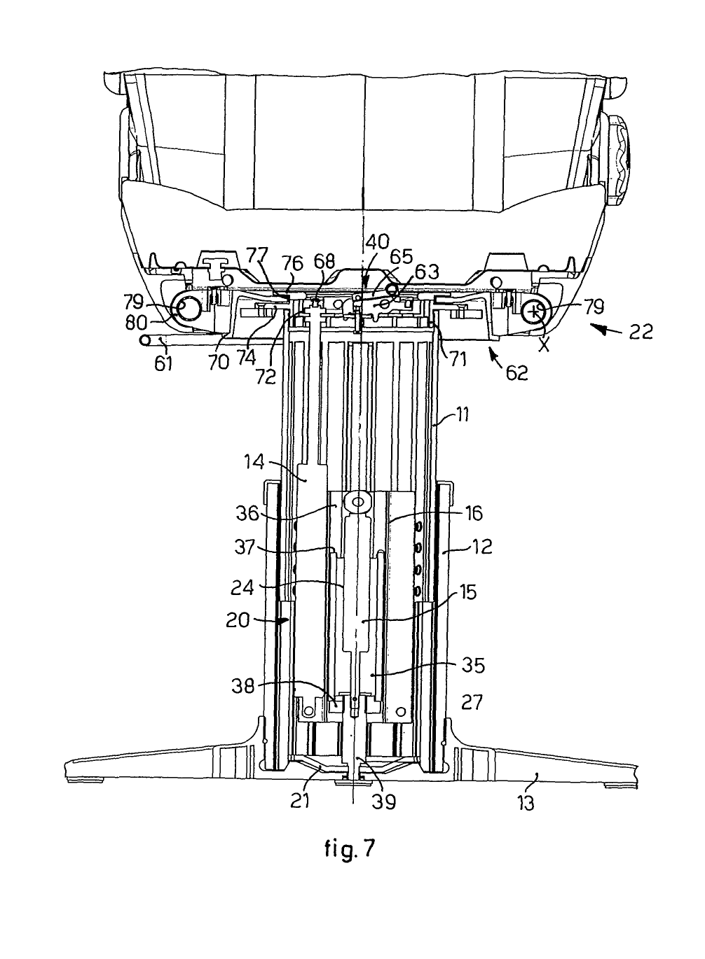

To this purpose, the gas springs 14 are connected, directly or indirectly, to a first flange 71 of a flange support system 50 (FIGS. 7, 8 and 9) in turn connected to the rod 11, as will be shown in more detail hereafter in the description, and on which the elastic force of extension or contraction of the gas springs 14 is performed. In this way, advantageously, the connection regions of the gas springs 14 and the rod 11 do not interfere with the alternate axial motion of the rod 11.

Therefore, advantageously, the rod 11-cylinder 12 structure, alternately moved by the gas springs 14, is not subject to mechanical, radial or tangential stresses along the lateral surfaces 32, 33. In fact, only the reciprocal sliding of the rod 11-cylinder 12 occurs on the lateral surfaces 32, 33, whereas the thrust of the gas springs 14 occurs directly on the flange 72, which is not affected by the sliding coupling of the rod 11 with the cylinder 12.

The gas springs 14 are also connected to a third extrusion profile or central guide 16 by means of the coupling of attachment pins 18 with connection arms 85, made in a single piece with the central guide 16 (FIGS. 3, 5, 6 and 7).

The central guide 16 is also inserted inside and slidingly coupled with the rod 11, thanks to sliding platelets 28 fixed on protuberances 17 of the central guide 16, in this specific case two of which associated with the arms 85 (FIG. 3).

The sliding platelets 28 are guided, in their alternate movement, along the axial grooves 29 made on the internal lateral surface 31 of the rod 11 and, advantageously, made during the extrusion of the latter (FIG. 3).

Therefore, when the gas springs 14 are driven, in extension and/or contraction, they are displaced axially both with the rod 11, and consequently the seat-part 22 is positioned on the level desired by the user, and also with the central guide 16.

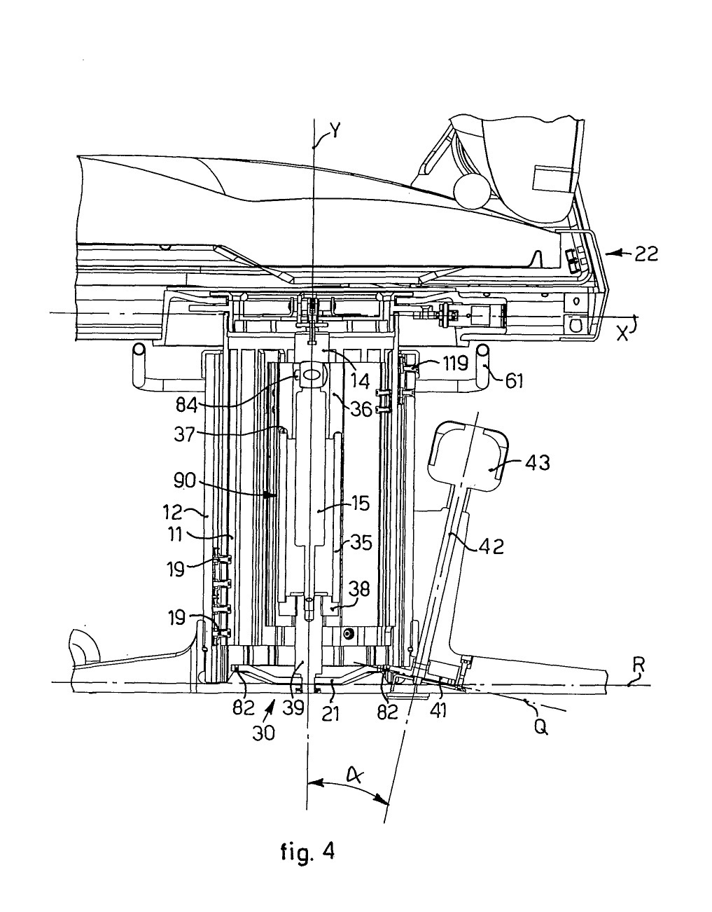

A hydraulic shock absorber 15 (FIGS. 3 and 4) is inserted slidingly, along the axis Y, into the central guide 16, and is also made solid with said central guide 16. The gas springs 14 are disposed on diametrically opposite sides with respect to the hydraulic shock absorber 15.

The hydraulic shock absorber 15 is inserted at least partly into a central bushing 36 that supports the axial movement, and is solidly connected to the latter, by means of a connection pin 84 (FIGS. 1 and 2).

Below, the hydraulic shock absorber 15 is rigidly supported by a support block 39, rigidly fixed to the supporting base 13, and aligned with the axis Y (FIGS. 4 and 7). The central bushing 36 is in turn guided axially in the central guide 16, sliding inside it together with the hydraulic shock absorber 15.

The hydraulic shock absorber 15 is able to extend and contract axially, with a predetermined elastic force, to absorb the vibrations and allow the springing of the seat-part 22.

The gas springs 14 thus cooperate with said hydraulic shock absorber 15. In fact, the gas springs 14 are connected to the central guide 16, in turn solid with the hydraulic shock absorber 15.

As we said, the position of the seat-part 22 is determined by rigidly clamping the position, extended or contracted (FIGS. 1, 2, 5 and 6) of the gas springs 14, which are connected to the central guide 16. In this condition, the weight of the seat-part 22 and of the user rests on the gas springs 14, which discharge the weight onto the central guide 16 and from here onto the bushing 36 and the hydraulic shock absorber 15.

Moreover, the central bushing 36 has a lower end 37, which presses directly on a helical spring 35.

The overall weight of the seat-part 22 and of the user is discharged onto the helical spring 35, so as to obtain an advantageous springing of the upper part of the seat 100.

The axial sliding of the central guide 16 with respect to the rod 11 is thus advantageously used in order to absorb the vibrations by means of the hydraulic shock absorber 15 and the helical spring 35.

The helical spring 35 is inserted into the lower part 27 of the central guide 16, below the hydraulic shock absorber 15 and is coaxially aligned with the rod 11-cylinder 12 system. At least the lower portion 24 of the hydraulic shock absorber 15 is axially housed inside the helical spring 35, when it is in its contracted position.

The helical spring 35 is thus able to be alternately compressed and extended, along a springing travel CM (FIGS. 5 and 6) of some centimeters, in order to absorb the vibrations and shocks that are propagated axially, from the supporting plane on the ground towards the seat-part 22, and vice versa, during the normal use of the seat 100.

In substance, the hydraulic shock absorber 15 is partly inserted into the central bushing 36 and partly into the helical spring 35, thus achieving over all a springing unit 90, of the compact type that advantageously slides inside the central guide 16, and is supported by the support block 39.

The present invention thus allows to absorb the vibrations, thanks to the contraction or extension of the helical spring 35, and the consequent sliding of the springing device 20 and the central guide 16 along the rod 11.

The helical spring 35 rests in turn on a thrust block 38, mobile along the axis Y (FIGS. 1, 2 and 4), which is part of a device to adjust the pre-load 30 of the helical spring 35 (FIG. 4).

In fact, the thrust block 38 is constrained to slide axially along the support block 39 (FIGS. 5 and 6) which is rigidly fixed to the device to adjust the pre-load 30. The thrust block 38 is thus mobile axially, to press against the helical spring 35, so as to selectively determine the axial load of the helical spring 35 to a desired level of pre-compression, that is, to selectively regulate the force with which the thrust block 38 thrusts against the helical spring 35.

The device to adjust the pre-load 30 also comprises a system of wheels, engaging with each other (FIG. 4), so that the movement of rotation of one transmits a determinate movement to another, having a first cup-type wheel 21, which develops around an axis substantially coinciding with the axis Y of the rod 11-cylinder 12 system.

The first cup-type wheel 21 is disposed on the bottom of the supporting base 13 and therefore lies on a plane R substantially perpendicular to the axis Y (FIG. 4) and has engaging teeth 82 also disposed substantially orthogonal, or radial, with respect to the axis Y. The first cup-type wheel 21 is rotatably connected to the support block 39 and when it is made to rotate, it moves the support block 38 alternately by means of a grub screw mechanism or “spiral” screw provided in the support block 39, of a known type, in order to press from below against the helical spring 35 (FIG. 4). The first cup-type wheel 21 engages a corresponding second adjustment wheel 41, also disposed inside the supporting base 13 of the seat-part 22. The second adjustment wheel 41 lies on a plane Q and is provided with a command rod 42, maneuverable with an associated adjustment knob 43, in order to make said first and second wheels 21, 41 rotate, and to achieve the desired pre-loading of the helical spring 35. According to a characteristic feature of the invention, the first cup-type wheel 21 and the second adjustment wheel 41 lie on planes R and Q forming an acute angle α (FIG. 4), with an amplitude of some degrees, for example comprised between about 0 degrees and 45 degrees, preferably between 0 degrees and 15 degrees, so that the command rod 42 also forms the same acute angle α with the axis Y of the rod 11-cylinder 12 system (FIG. 4), and is therefore disposed in proximity of the base support 23 of the seat-part 22.

In substance, the command rod 42 and the adjustment knob 43 are ergonomic, that is, they are advantageously positioned in proximity with the seat-part 22, and the user can easily drive them directly when he is seated, without having to bend or get off the seat 100.

And now, again referring to the drive of the gas springs 14, they are commandable irrespective of the angular position of the seat-part 22, that is, advantageously they can be driven also during the rotation of the seat-part 22 on itself.

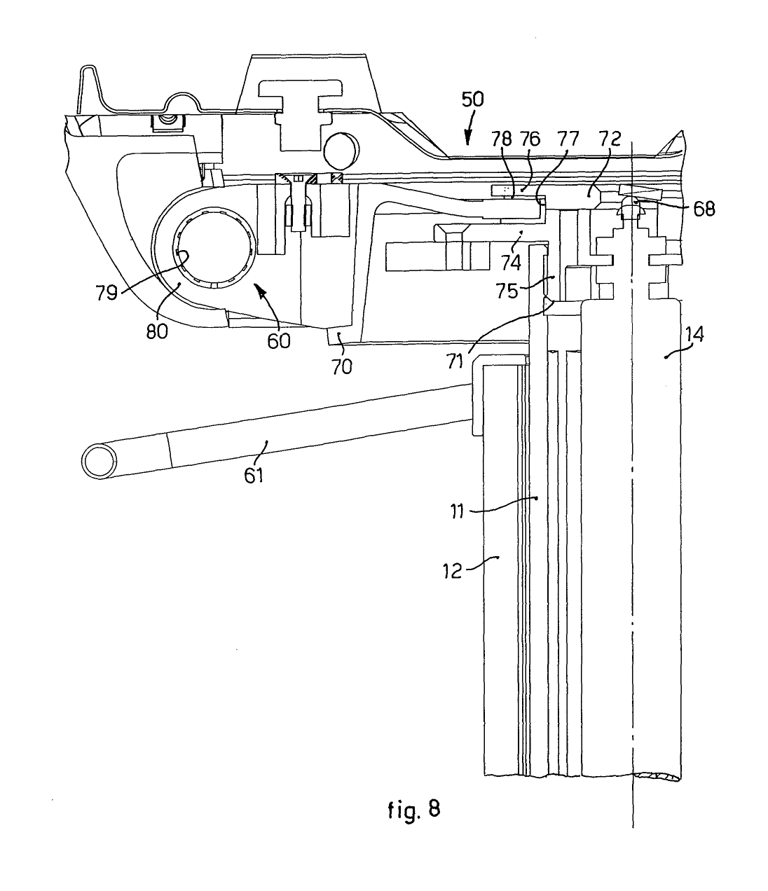

To this purpose, the seat 100 is provided with a spring command device 40 (FIGS. 7 and 8) which allows the seat-part 22 of the seat 100 to rotate through 360 degrees with respect to the base support 23 adjustable in height and, simultaneously, to drive the gas springs 14. The spring command device 40 comprises a command lever 61 which is advantageously ergonomic because it is directly maneuverable by the user, being pivoted on the lower surface 62 of the seat-part 22. The command lever 61 thus always rotates together with the seat-part 22, and commands, from any angular position whatsoever, the drive of the gas springs 14 which, on the contrary, are in a predetermined angular and normally stable position in the rod 11.

In particular, said command lever 61 commands, by means of a compound lever 65, also rotating together with the seat-part 22, a piston 69 alternately mobile parallel to the axis Y of the rod 11-cylinder 12 system (FIG. 8).

The piston 69 is fixed to a rotary pin 66, in turn connected to a central platelet 64, developing substantially around an axis Y and which is thus alternately mobile in a vertical direction along the axis Y and rotary on itself. Therefore, the command lever 61 indirectly drives the central platelet 64 in a vertical direction, also during the rotation through 360 degrees, substantially achieving a rotational release. The central platelet 64 cooperates with two different mechanical connecting means 63 (FIG. 8), which drive the gas springs 14, with a vertical thrust (FIG. 8). To this purpose, the mechanical connecting means 63 are provided with a rotation seating 67, inside which the central platelet 64 is inserted rotatably, so as to be able to rotate, while remaining inserted in the rotation seating 67, and simultaneously thrust, selectively, the mechanical connecting means 63. The mechanical connecting means 63 control the gas springs 14, selectively acting on the clamping/release mechanism 68 of the gas springs 14 (FIGS. 7 and 8).

To this purpose, the mechanical connecting means 63 are pivoted on axes substantially perpendicular to the axis Y of the rod 11-cylinder 12 system, so that, when they are moved by the central platelet 64 towards the seat-part 22, they rotate in a clock-wise direction, going to an active position in which they contact with a predetermined force the clamping/release rods 68 and release the gas springs 14 (FIGS. 7 and 8), and vice versa in an inactive position.

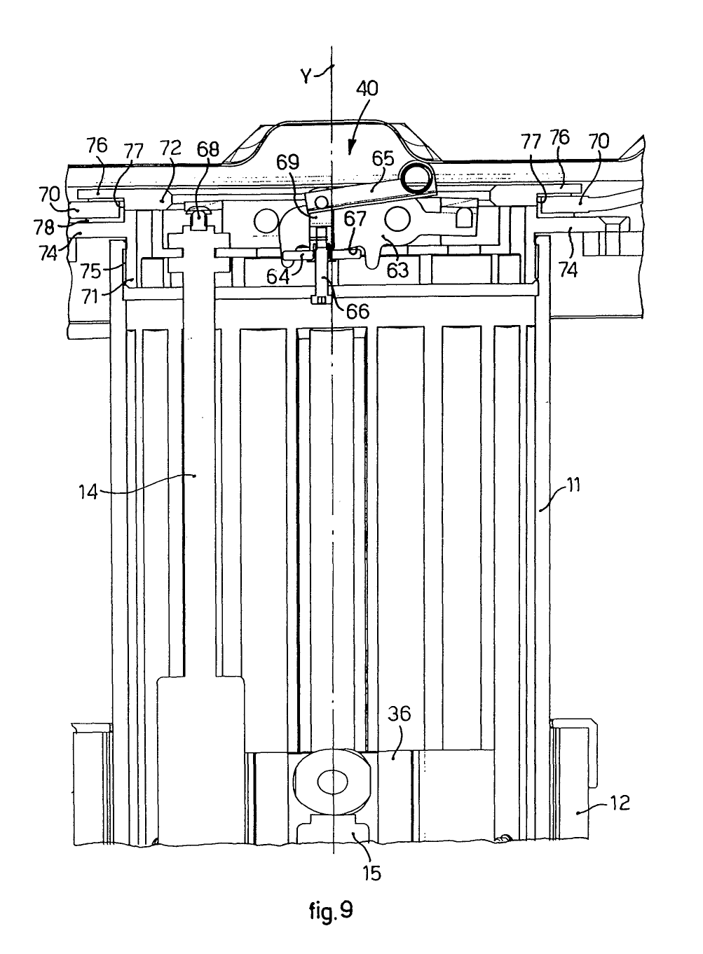

To allow the rotation through 360 degrees of the seat-part 22, the seat 100 is provided with a support system with coaxial flanges 50 (FIGS. 7 and 9), both rotary and fixed, which comprises a pair of fixed flanges 71, 72, associated axially with the rod 11-cylinder 12 system and disposed below the lower surface 62 of the seat-part 22.

The first flange 71 and the second flange 72 are solidly fixed to each other at a reciprocal axial distance, predetermined and adjustable, during the assembly step.

The first flange 71 is formed by a threaded cylindrical part 75, fixed inside the rod 11, and by a first circular crown 74 that projects from the threaded cylindrical part 75, so as to protrude from the rod 11. The gas springs 14 are fixed to through holes of the first flange 71 (FIGS. 7, 8 and 9).

The second flange 72 is also provided with a second circular crown 76 that projects radially, in an external direction with respect to the rod 11 (FIG. 9).

The second circular crown 76 defines, together with the first circular crown 74, an annular sliding seating 77, into which an external flange 70 is inserted in support and along which it rotates sliding (FIG. 9). The external flange 70 is fixed to the seat-part 22, so as to rotate together with it and, substantially, it supports the seat-part 22 rotatably with respect to the base support 23. Sliding pads 78 are disposed in the annular seating 77, advantageously made of polymer material with a low friction coefficient, so as to improve the sliding of the external flange 70 and the pair of fixed flanges 71, 72 (FIGS. 8 and 9).

The seat-part 22 is not only adjustable in height and rotatable through 360 degrees, but is also adjustable horizontally, that is, along the plane on which it lies, substantially orthogonal to the axis of the rod 11-cylinder 12 system.

To this purpose, the seat-part 22 is provided with a device to adjust the horizontal position 60 (FIG. 9), which comprises two horizontal tubes 79, advantageously obtained as extrusion profiles. The tubes 79 are solidly fixed to the seat-part 22 and disposed diametrically opposite with respect to the base support 23. The tubes 79 are able to slide inside horizontal bushings 80 with a horizontal longitudinal axis X, orthogonal to the axis Y, and which are connected instead to the external flange 70.

The seat-part 22 is thus advantageously able to slide horizontally with respect to the base support 23. The position of the tubular profiles 79 with respect to the bushings 80, and hence the seat-part 22, is selectively clamped by means of clamping teeth.

It is clear that modifications and/or additions of parts may be made to the springing device 20 as described heretofore, without departing from the field and scope of the present invention.

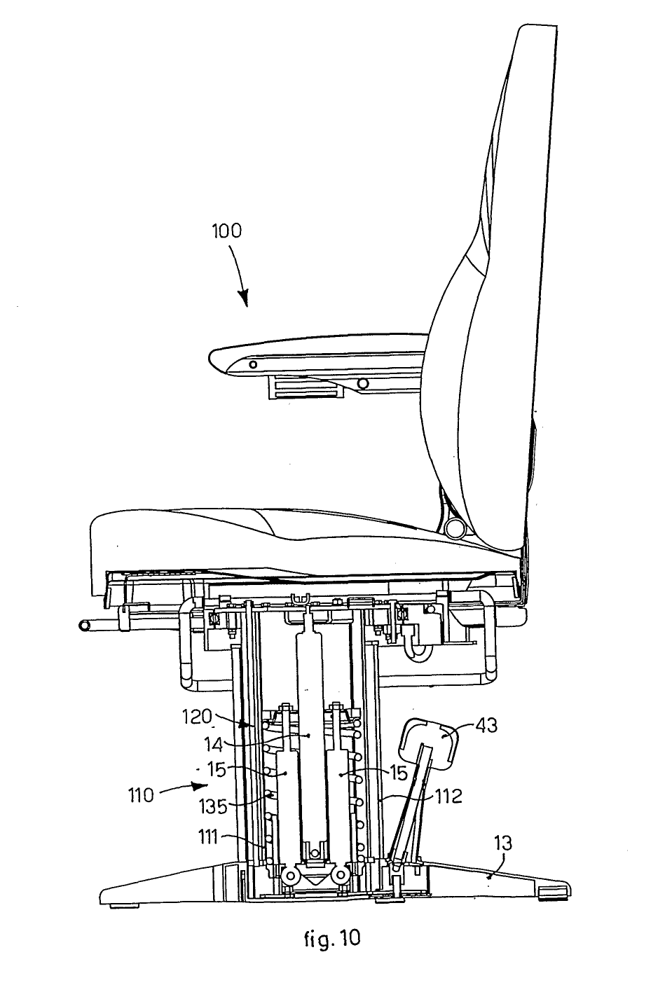

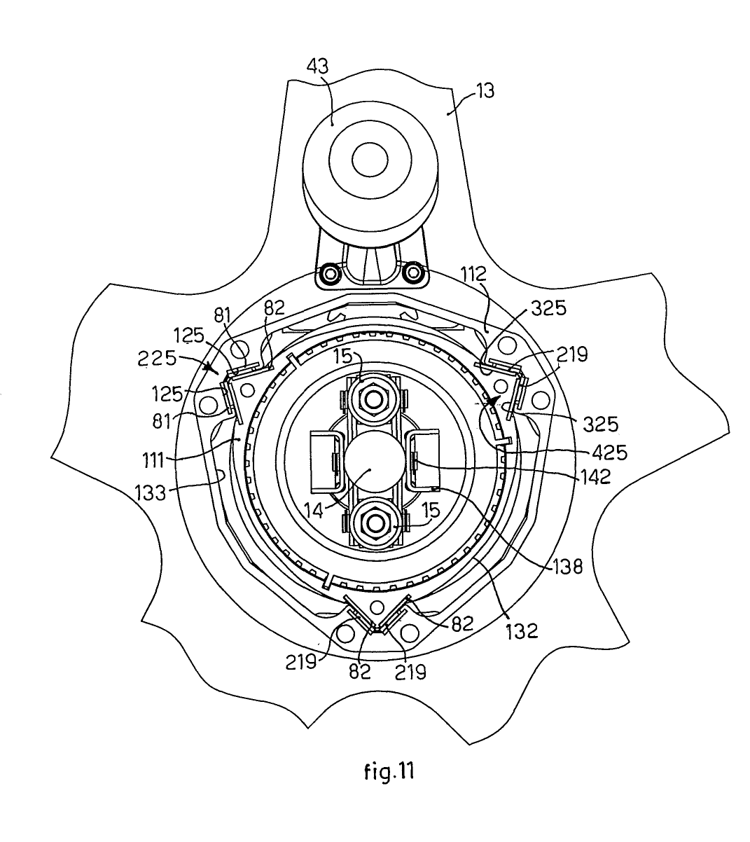

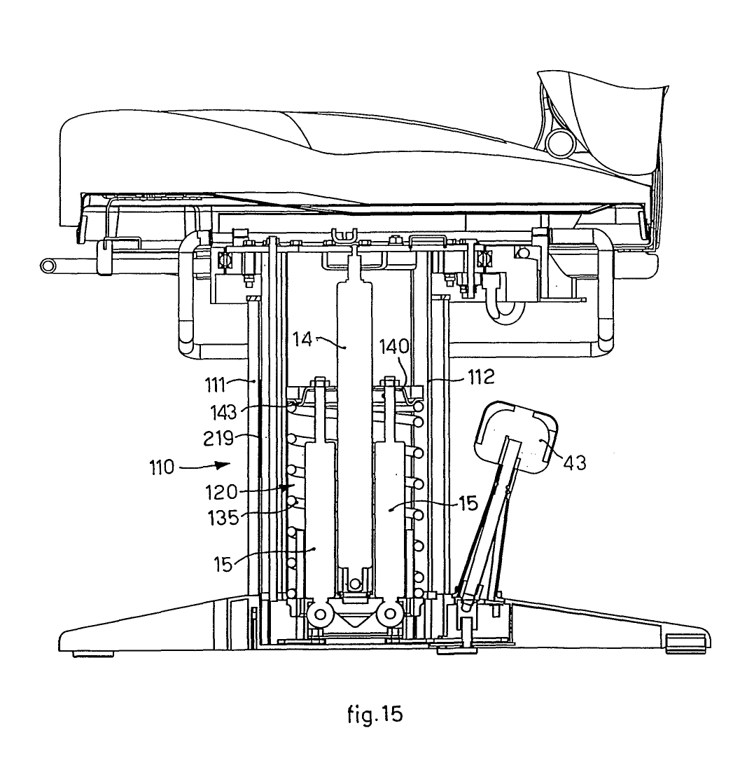

In FIGS. 10, 11, 15 and 16 a variant of the vertical springing device is shown, and identified by the reference number 120, where the same reference numbers denote equivalent parts.

The vertical springing device 120 is disposed inside the rod 111 and has a single gas spring 14 which is disposed centrally, that is, coaxial both with the cylinder 112 and also with the rod 111, and two hydraulic shock absorbers 15 which are disposed at the sides of the gas spring 14, on diametrically opposite sides of the gas spring 14. Around the shock absorbers 15 a helical spring 135 is disposed, also coaxial with the rod 111 and the cylinder 112.

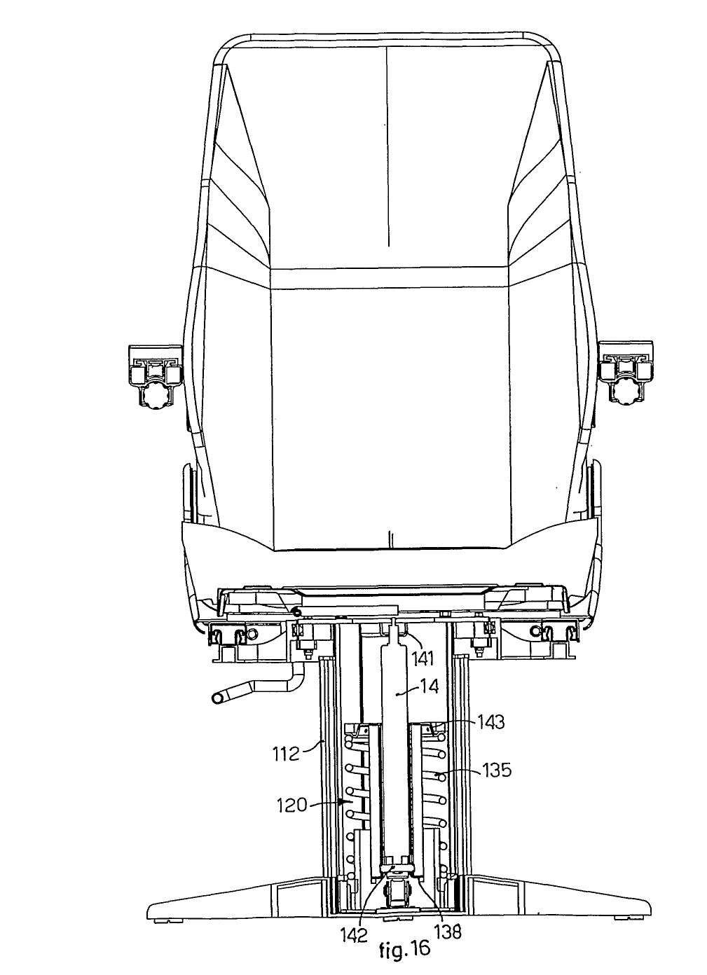

The gas spring 14 is connected at the upper part with the seat-part 22 by means of a connection element or profile 141, with a U-shaped cross section (FIG. 16).

Adjacent to the gas spring 14 two connection elements or profiles 138 are disposed, with a C-shaped cross section. The profiles 138 are fixed at the lower part to the end of the gas spring 14 by means of a pin 142, whereas at the upper part they are welded to a circular plate or cap 143. The hydraulic shock absorbers 15 are also fixed to the cap 143, so that the gas spring 14 and the hydraulic shock absorbers 15 are made solid with each other. The cap 143 rests with its lower part on the upper end of the spring 135.

Therefore, the stresses and vibrations on the seat-part 22 are transmitted to the gas spring 14 and from this to the shock absorbers 15 and the spring 135, and are consequently deadened.

In FIGS. 10, 11, 15 and 16, a variant of the guide device according to the invention is shown, and identified by the reference number 110, where the same reference numbers denote equivalent parts.

The guide device 110 has the internal telescopic element or rod 111 which is axially sliding with respect to a fixed cylinder 112, disposed outside.

To promote the axial sliding of the rod 111 and the cylinder 112, steel rollers 219 are provided, which are interposed so as to roll on relative steel blades 81 disposed along the internal surface 133 of the cylinder 112 and on relative steel blades 82, disposed along the external surface 132 of the rod 111.

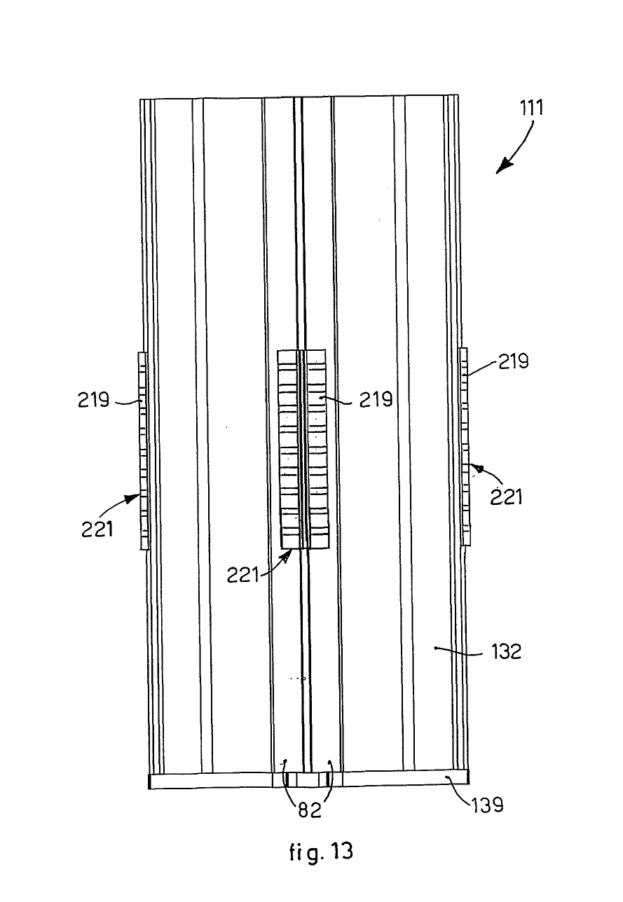

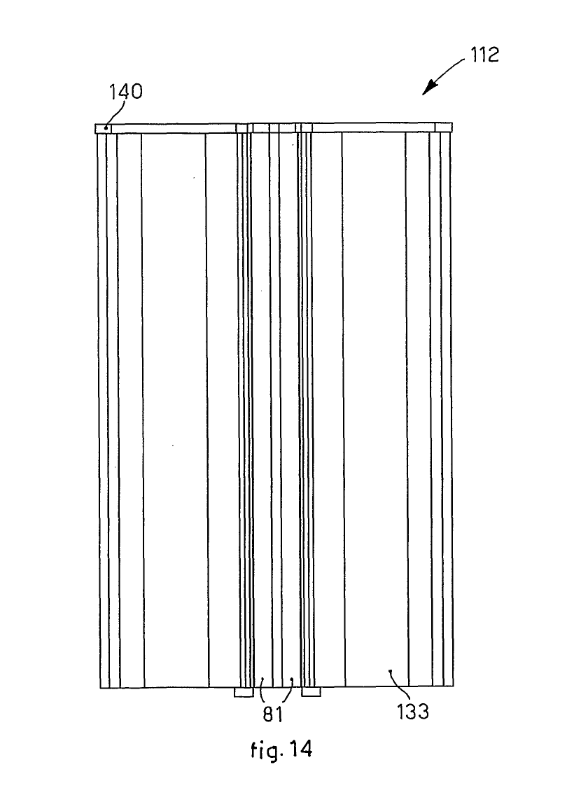

The blades 81 and 82 are clamped in the axial direction by at least two flanges 139 and 140, in particular a flange 139 mounted on the lower end of the rod 111 (FIG. 13), and a flange 140 mounted on the upper end of the cylinder 112 (FIG. 14).

The flanges also confer great axial rigidity to the rod 111 and the cylinder 112.

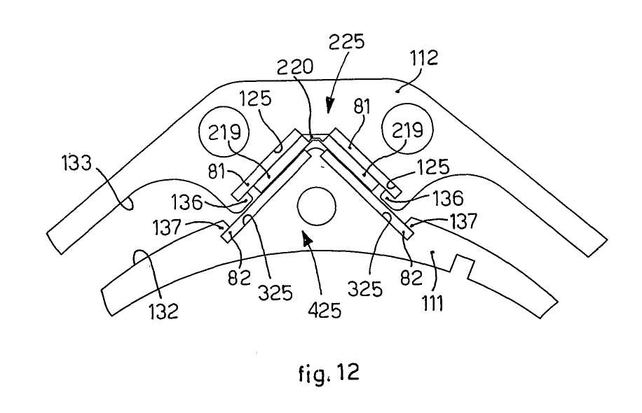

In particular, the cross section of the cylinder 112 is substantially of the tri-lobed type, with lobes disposed at 120 degrees with respect to the axis Y, as can be seen in the drawings. In correspondence with each lobe, on the internal surface 133 of the cylinder 112, two longitudinal seatings 125 are made by extrusion of the profile, disposed at 90 degrees with respect to each other. The seatings 125 are grouped in pairs of seatings 225 and therefore there are three pairs of seatings 225 disposed at 120 degrees, and each pair 225 defines a concave configuration, like an upside down V with an angle of 90 degrees. Each seating 125 is provided with a retaining tooth 136, which defines a relative undercut. Said steel blades 81 are disposed in the seatings 125, inserted with a portion thereof in the corresponding undercuts and retained in their position by the relative teeth 136 (FIG. 12).

Correspondingly, on the external surface 132 of the rod 111 longitudinal seatings 325 are made, by means of extrusion of the profile, which are grouped in three pairs of seatings 425, each couple 425 being in a mating position with a relative pair of seatings 225. Each pair of seatings 425 defines a relative convex configuration, like an upside down V with an angle of 90 degrees, which is geometrically coupled with a pair of seatings 225.

Each seating 325 is provided with a retaining tooth 137, which delimits a relative undercut. Said steel blades 82 are disposed in the seatings 225, inserted with a portion thereof in the corresponding undercuts and retained in their position by the relative teeth 137 (FIG. 12).

The steel rollers 219 are grouped by means of cages of rollers 221 about 80 millimeters long, in this specific case in groups of ten rollers. The cages 221 are used in pairs, connected by a plastic connection element 220 of the flexible type.

The cages of rollers 221 are inserted through interference, at the moment the guide device is assembled, between the cylinder 112 and the rod 111.

The pairs of cages 221 are disposed, in particular, at 90 degrees with respect to each other, between the opposite blades 81 and 82. The relative position of the cages 221, adjustable thanks to the connection element 220, is mating with the V shape of the seatings 125 and the upside down V shape of the seatings 325.

As we said, the rollers 219 of the cages 221 are able to roll along the blades 81 and 82, which function as a rolling track with high resistance to friction, allowing the rod 111 to slide with respect to the cylinder 112.

It is also clear that, although the present invention has been described with reference to some specific examples, a person of skill in the art shall certainly be able to achieve many other equivalent forms of springing device, having the characteristics as set forth in the claims and hence all coming within the field of protection defined thereby.

1. A vertical springing device to allow the vertical springing and absorption of vibrations of a first telescopic element, connected to a seat-part of a seat, with respect to a second fixed element, connected to a base of said seat, the device comprising:
adjustment means of the elastic type, disposed inside said first telescopic element and able to adjust in height the level of said first telescopic element with respect to said second fixed element, and
a springing mechanism, able to allow the vertical springing of said first telescopic element with respect to said second fixed element,
wherein said adjustment means comprises one or more gas or mechanical springs,
wherein said springing mechanism comprises springing means and deadening means, and
wherein said deadening means comprises a shock absorber disposed centrally, at the side of which two gas springs are disposed.

2-4. (canceled)

5. A springing device as in claim 1, wherein said springing means and said deadening means are coaxial with each other and axially associated by an annular element.

6. A springing device as in claim 1, comprising a third profile, connected both to said adjustment means and also to said springing mechanism.

7. A springing device as in claim 1, comprising a gas spring disposed centrally and wherein said deadening means comprise two shock absorbers disposed at the sides of said gas spring.

8. A springing device as in claim 1, wherein said springing means and said adjustment means are coaxial with respect to each other.

9. (canceled)

10. A springing device as in claim 1, also comprising an adjustment mechanism for pre-loading said springing means, which in turn comprises
a first toothed wheel able to rotate around said axis (Y), to selectively drive a grub screw mechanism able to translate axially a thrust block, which cooperates from below against said springing means, and
a second toothed wheel engaged with said first toothed wheel and driven by a command rod, which forms an acute angle (α) with respect to said axis (Y), to be near a substantially vertical position, or slightly inclined.

11. A springing device as in claim 10, wherein said angle (α) has a value of amplitude comprised between about 0 degrees and 45 degrees.

12. A springing device as in claim 1, wherein said second fixed element comprises a first profile shaped to define internally first vertical guide means, with which interposition means cooperates, interposed between said first telescopic element and said second fixed element, to promote the reciprocal axial sliding of said first telescopic element with respect to said second fixed element.

13. A springing device as in claim 12, wherein said interposition means comprises first sliding means, protruding radially from said first telescopic element.

14. (canceled)

15. A springing device as in claim 13, wherein said sliding means comprises pads fixed to the external surface of said first telescopic element and made of low friction coefficient material.

16-17. (canceled)

18. A springing device as in claim 12, wherein said second fixed element comprises second sliding means that protrude radially towards the inside and cooperate with the external surface of said first telescopic element.

19. A springing device as in claim 18, wherein said first telescopic element comprises a second profile shaped to define on the external surface thereof a plurality of flat faces with which said second sliding means cooperates.

20. (canceled)

21. A springing device as in claim 19, wherein said second profile is shaped to define internally second vertical guide means, with which third sliding means cooperates, protruding radially from a third profile disposed inside said first telescopic element.

22. A springing device as in claim 21, wherein said second guide means and said third sliding means are positioned radially at 120 degrees with respect to said longitudinal axis (Y) and are off-set angularly by 60 degrees with respect to said first guide means.

23. (canceled)

24. A springing device as in claim 12, wherein said interposition means comprises roller means.

25. A springing device as in claim 24, wherein said first guide means comprises first seatings made longitudinally on the internal surface of said second fixed element, into each of which a first metal blade is inserted, on which said roller means is able to roll.

26. A springing device as in claim 25, wherein on the external surface of said first telescopic element second seatings are made longitudinally, disposed in correspondence with said first seatings, into each of which a second metal blade is inserted, on which said roller means is able to roll.

27. A springing device as in claim 1, also comprising a command unit, able to selectively command said adjustment means and comprising in turn a command lever pivoted to the lower part of said seat-part and able to drive a central platelet, with which lever means cooperates, which controls said spring means to command, from any angular position of the seat-part, the drive of said adjustment means.

28. A springing device as in claim 1, also comprising a mechanism with coaxial flanges, which is able to allow the rotation through 360 degrees of said seat-part and is provided with a pair of flanges, solid with said first telescopic element and defining an annular seating, in which a rotary flange is able to slide rotatably, which is solid with said seat-part.

29. A seat for public transport means, for trams, buses, trucks, for office use or other, comprising a springing device as in claim 1.
